(19) United States
(12) Patent Application Publication
(10) Pub. No.: US 2013/0011304 A1
(43) Pub. Date: Jan. 10, 2013

(54) FILTERING STRUCTURE, INCLUDING PLUGGING MATERIAL

(75) Inventor: Matthias Schumann, Plan D'Orgon (FR)

(73) Assignee: Saint-Gobain Centre De Recherches Et D'Etudes Europeen, Courbevoie (FR)

(21) Appl. No.: 13/635,699

(22) PCT Filed: Mar. 15, 2011
(86) PCT No.: PCT/FR11/50510

§ 371 Date: Sep. 18, 2012

(30) Foreign Application Priority Data
Mar. 19, 2010 (FR) 1051980

(51) Int. Cl. B01D 53/38; H05B 6/64; B01D 46/24

(52) U.S. Cl. 422/168; 55/523; 55/385.3; 264/489

(57) ABSTRACT

Filter structure of the honeycomb type for filtering particulate-laden gases, said structure being characterized in that:
a) the filtering walls of said honeycomb structure are made of a material having, after firing, an average thermal expansion coefficient, measured between 25 and 1100° C., of less than 2.5×10⁻⁶ K⁻¹; and
b)the material constituting the plugs comprises:
   a filler formed from refractory grains, the melting temperature of which is above 1500° C., and the median diameter of which is between 5 and 50 microns; and
   a glassy binder phase.

The invention relates to the field of filter structures, optionally catalytic filter structures, especially used in an exhaust line of a diesel internal combustion engine.

Catalytic filters for the treatment of gases and for the elimination of soot particles coming from a diesel engine are well known in the prior art. Usually these structures all have a honeycomb structure, one of the faces of the structure allowing entry of the exhaust gases to be treated and the other face allowing exit of the treated exhaust gases. The structure comprises, between the entry and exit faces, an assembly of adjacent ducts or channels having mutually parallel axes and separated by porous walls. The ducts are closed off at one or other of their ends so as to define inlet chambers opening onto the entry face and outlet chambers opening onto the exit face. The channels are alternately closed off in such an order that the exhaust gases, in the course of their passage through the honeycomb body, are forced to pass through the sidewalls of the inlet channels before rejoining the outlet channels. In this way, the particulates or soot particles are deposited and accumulate on the porous walls of the filter body.

During their use, it is known that particulate filters are subjected to a succession of filtration (soot accumulation) and regeneration (soot elimination) phases. During the filtration phases, the soot particles emitted by the engine are retained and deposited inside the filter. During the regeneration phases, the soot particles are burnt off inside the filter, so as to restore its filtering properties. Usually, the filters are made of a porous ceramic material, for example cordierite or silicon carbide.

Silicon carbide filters produced with these structures are for example described in the patent applications EP 816 065, EP 1 142 619 and EP 1 455 923 or else WO 2004/090294 and WO 2004/065088, to which a person skilled in the art may for example refer for further precision and details, both as regards the description of filters according to the present invention and as regards the process for obtaining them. Advantageously, these filters exhibit very high chemical inertness with respect to soot particles and hot gases, but they have a somewhat high thermal expansion coefficient which means that, in order to produce large filters, a number of monolithic elements (called monoliths) have to be joined together by a joint or jointing cement into a filter block, so as to reduce their thermomechanical stresses. Because of the high mechanical strength of recrystallized SiC materials, it is possible to produce filters with thin filtering walls of high porosity and with a very satisfactory filtration efficiency.

Cordierite filters have also been used for a long time because of their low cost. Because of the very low thermal expansion coefficient of this material, in the normal operating temperature range of a filter it is possible to produce monolithic filters of large size.

A material of the aluminum titanate type may also have a low average thermal expansion coefficient, i.e. typically between 2.5×10⁻⁶ K⁻¹ as measured according to the standards in force, between 25° C. and 1000° C. This material is also characterized by a higher refractoriness and a higher corrosion resistance than those of cordierite. Thus, it is possible to produce large monolithic filters provided that, however, thermal stability of the aluminum titanate is controlled, especially during the filter regeneration phases. The term “thermal stability” is understood to mean the capability of a material based on aluminate titanate not to be decomposed, at high temperature, into two separate phases, namely titanium oxide TiO₂ and aluminum oxide Al₂O₃, under the normal operating conditions of a particulate filter.

Monolithic filters have thus been described in patent application WO 2004/011124, which proposes structures based on 60 to 90% aluminum titanate by weight, reinforced with mullite in an amount of 10 to 40% by weight. According to the authors, such a filter thus obtained has improved endurance. According to another construction, patent application EP 1 741 684 describes a filter having a low expansion coefficient, the aluminum titanate main phase of which is stabilized, on the one hand, by substituting a fraction of the Al atoms with Mg atoms in the Al₂TiO₅ crystal lattice within a solid solution and, on the other hand, by substituting a fraction of the Al atoms on the surface of said solid solution with Si atoms, provided in the structure by an intergranular additional phase of the potassium sodium aluminosilicate type, especially a feldspar.

These monolithic structures are typically extruded and then, before they are fired, they are closed off at one and the other of their ends, usually by a material similar or even identical to that constituting the filtering walls, so as to define inlet chambers and outlet chambers as described above.

It turns out that the method for closing off or plugging with the materials normally used on both faces of an extruded structure, especially one of large size, results however in cracks appearing in the filters, especially in the region corresponding to their face that bears on the firing support. The term “large size” is understood to mean particularly structures having a diameter greater than 100 mm or a cross section greater than 75 cm². Without this being considered as definitively understood, these cracks appear to be due to stresses associated with the difference in shrinkage within the structure between the plugged channels in the green state, i.e. before the filter is fired, and those that are not plugged. The term “shrinkage” is understood, in the context of the present invention, to mean the difference along one dimension of the filter in question, for example the length, of said dimension before and after the filter is fired. This shrinkage effect of the alumina-titanate-based material often remains at low temperature, that is to say at a temperature below 400° C., and especially at ambient temperature.

According to another alternative, a method has also been proposed for plugging or closing off the channels of a structure that has already been sintered. The advantage of such a method may be that it saves a plugging operation, especially in the event of the filter being scrapped after firing, because of the presence of defects associated with the firing or with the previous process steps but only revealed during firing. Furthermore, according to another advantage of such a method, the firing of honeycomb ceramic structures seems much more homogenous when its channels are not plugged. Evacuation of the gases resulting from the binder removal operation could thus be facilitated, thus reducing the risk of cracking associated with binder removal. Such a method would make it possible in the end to obtain, starting with a mixture of precursor materials initially more highly filled with pore-forming agent, structures that in the end are more porous, and thus to reduce the pressure drop associated with the filter in operation in an exhaust line, or even to integrate more easily an additional catalytic function of decontaminating the exhaust gases in said filter by depositing thereon a coating based on active metals.

However, the methods described in the prior art, involving the plugging step after the sintering or firing of the structure, also prove to be unsatisfactory, as has been observed by the applicant. In particular, cracks still appear between the plugs and the walls of the closed-off channels during the additional firing of said plugs. The problem this time could be attributed to a difference in dilatometric behavior between the material constituting the plug and that of the walls. The solutions proposed hitherto consist in adapting the plugging mixture to that of the material of the walls, in particular for the purpose of making the dilatometric behavior of the materials more uniform. Thus, patent applications US 2006/0272306 and WO 2009/073092 describe as fundamental principle the creation of a dilatometric curve during firing of the plugging material, which curve is close to that of the already sintered material that constitutes the walls of the structure. The structures produced according to these principles show that the plugs adhere satisfactorily to the walls after the first plug firing heat treatment, for example at 1000° C. in air. However, the applicant has found that the adhesion of the plugs to the walls of the filter structure greatly deteriorates with the increasing number of soot combustion cycles in the operating filter. In particular, cracks have appeared with the use of such plugging materials, for example after 10 thermal cycles between 500 and 1100° C. on a filter placed in a diesel engine exhaust line. Thus, cracking between the plug and the wall has been observed in the great majority of filters studied, as will be illustrated in the rest of the present description. This phenomenon may lead to insufficient sealing and consequently to a filter that has too low a filtration efficiency in operation. If plugs become detached from the walls of the structure during operation in the exhaust line, the filter may then become ineffective and even have to be changed.

The present invention particularly addresses filters in which the filtering walls are made of a material having a low average thermal expansion coefficient, i.e. less than 2.5×10⁻⁶ K⁻¹, as measured between 25 and 1100° C., and having at least some of the channels closed off after the honeycomb has been sintered or fired. The object of the present invention is thus to provide a honeycomb filter structure that solves all the aforementioned problems and in particular has plugs that are more stable and have better cohesion with the walls, most particularly during the successive regeneration cycles for regenerating the filter when it is employed in a motor vehicle exhaust line.

More particularly, the research carried out by the applicant has demonstrated that, contrary to the indications and principles provided in the documents already published, in particular in patent applications US 2006/0272306 and WO 2009/073092, in order to obtain a structure as described above it was not opportune to adapt the plugging mixture to that of the material of the walls, for the purpose of making the thermal expansion coefficients of the materials uniform, rather that, in contrast, a large difference between said coefficients can, under certain conditions, make it possible to obtain lasting adhesion under the conventional conditions of using a particulate filter.

The research carried out has especially demonstrated that other parameters could be taken into account in order to obtain a filter structure produced by plugging after firing that solves the aforementioned problems.

In its most general form, the present invention thus relates to a filter structure of the honeycomb type for filtering particulate-laden gases, comprising an assembly of adjacent longitudinal channels having mutually parallel axes and separated by porous filtering walls, said channels being alternately plugged at one or other of the ends of the structure so as to define inlet and outlet channels for the gas to be filtered, and so as to force said gas to pass through the porous walls separating the inlet channels from the outlet channels, said structure being characterized in that:

a) the filtering walls of said honeycomb structure are made of a material having, after firing, an average thermal expansion coefficient, measured between 25 and 1100° C., of less than 2.5×10⁻⁶ K⁻¹; and

b) the material constituting the plugs comprises:
a filler formed from refractory grains, the melting point of which is above 1300° C., even above 1500° C., and the median diameter of which is between 5 and 50 microns; and
a glassy binder phase, the composition of which satisfies the following formulation, in percentages by weight of the oxides:
SiO₂: between 50 and 95%;
RO: between 0.1 and 15%, RO representing an oxide of an alkaline-earth metal or the sum of the alkaline-earth metal oxides in the glassy phase;
R₂′O: between 0.1 and 10%, R₂′0 representing an oxide of an alkali metal or the sum of the alkali metal oxides in the glassy phase;
Al₂O₃: less than 20%;
B₂O₃: less than 10%;
MgO: less than 5%; and

c) the average thermal expansion coefficient (TEC) of said material constituting the plugs, measured between 25 and 1100° , equal to not stressed, is at least equal to 4.8×10⁻⁶ K⁻¹, preferably at least equal to 5.0×10⁻⁶ K⁻¹. Moreover the coefficient TEC is preferably less than 10×10⁻⁶ K⁻¹.

In the present description, when the thermal expansion efficient is mentioned, unless otherwise indicated this is conventionally measured when not stressed (or under no load) on the material analyzed.

The term RO is understood to mean an oxide of an alkaline-earth metal R, preferably chosen from the group consisting of Ca, Sr and Ba, or the sum of the percentages by weight of the oxides CaO, SrO or BaO in the above formulation, if said glassy phase contains more than one alkaline-earth metal.

The term R₂′O is understood to mean an oxide of an alkali metal R′, preferably chosen from the group consisting of Na and K, or the sum of the percentages by weight of the oxides Na₂O or K₂O in the above formulation, if said glassy phase contains more than one alkali metal.

The thermal expansion coefficient of the material constituting the walls is measured in air using dilatometry techniques well known to those skilled in the art, such as for example that reported in the standard NFB40308. The thermal expansion, expressed as a percentage, corresponds to an elongation (if the variation is positive) or to a shrinkage (if the variation is negative) of the material under the effect of an increase in the temperature. The rate of increase is generally between 1 and 10° C./minute, preferably around 5° C./minute. The measurement is typically carried out with dilatometers well known to those skilled in the art, such as those of the Adamel or Setaram type comprising, in particular, a chamber for raising the temperature, a push-rod in contact with a specimen of the material to be tested, which is provided with a displacement sensor for recording the dimensional variations of the specimen. When no stress is applied, only a slight force is exerted on the push-rod to maintain contact with the specimen, the pressure on the specimen being very much less than 0.05 MPa. If necessary, the specimen may be machined so as to obtain satisfactory planarity and parallelism between the contact face and the opposite face. Ideally, these faces should not show any visible defects and the difference between any two length measurements taken by the caliper between the contact face and the opposite face must typically be less than 0.2 mm for an average length of between 10 and 50 mm. Preferably, the specimen has a square cross section, its diagonal typically being between 0.1 and 0.5 times its length. Preferably, the push-rod is made of dense alumina so as to avoid any reaction with the material to be tested and the cross section of the end of the push-rod in contact with the specimen is at least as large as that of the specimen so as to ensure contact with the entire face of the specimen on the push-rod side.

According to another possible aspect of the present invention, the average thermal expansion coefficient of said material constituting the plugs, measured between 25 and 1100° C. and this time under a load of 0.1 MPa (megapascal), is preferably at least equal to 4.5×10⁻⁶ ^{K}⁻¹, preferably at least equal to 5.0×10⁻⁶ K⁻¹.

It has been found that, in the context of the present invention, a pressure of 0.1 MPa appears to be representative of the backpressure exerted by the walls of the structure on the plug material when the filter is operating at temperature, especially during the regeneration phases undergone by a filter in service in an exhaust line. Measuring the thermal expansion coefficient under such a load allows, according to the invention, a finer selection of materials that can be used in constituting the materials according to the invention. Such a thermal expansion coefficient of the plugging material is measured in air under a load of 0.1 MPa, for example on a specimen of the plugging material after firing under the same conditions as described above, the pressure exerted by the push-rod on the specimen, that is to say the calculated pressure relative to the contact face of the specimen, this time being 0.1 MPa. The thermal expansion coefficient under load is determined in the same way as described above in the case of the thermal expansion coefficient in the absence of stress. The reference state of the measurement is the starting state of the specimen under load before the temperature is raised. To obtain the best precision, the dimensional variations under load are preferably measured on a structure specimen along the longest dimension of the specimen.

According to the invention, it is preferred to choose a material for constituting the plugs that has a shrinkage, measured between 25 and 1100° C. and under a load of 0.1 MPa, of less than 2.5%, preferably less than 2.0%.

The under-load shrinkage of the plugging material may be easily determined by simple analysis of the dilatometric curve obtained by measuring the thermal expansion coefficient under the above load of the specimen and by directly reading off the shrinkage after heating to 1100° C. and returning to room temperature. According to the present invention, the shrinkage of the material conventionally represents the difference along one dimension of the specimen of the ceramic material, preferably the longest one, measured before and after the heat treatment relative to the initial dimension of said specimen.

According to the criteria of the present invention, the constituent of the composition of the glassy binder phase may especially vary in the following proportions, in percentages by weight of the oxides:
SiO₂: between 65 and 95%, preferably between 70 and 90%;
CaO: between 0.5 and 15%;
Na₂O: between 0.05 and 10%;
CaO+Na₂O: between 3 and 25%, for example between 10 and 20%;
Al₂O₃: less than 15%, preferably less than 10%;
B₂O₃: less than 10%, preferably less than 5%; and
MgO: less than 5%.

According to a first embodiment of the invention, the glassy binder phase may especially comprise, in percentages by weight of the oxides:

SiO₂: between 70 and 85%, preferably between 75 and 80%;
B₂O₃: between 1 and 10%, preferably between 1 and 5%;
CaO: between 5 and 15%;
Al₂O₃: between 4 and 10%; and
SrO+BaO: less than 1%.

In the above formulation, good adhesion results were obtained in particular when R′₂O, in the sense described above, is less than 3% or less than 1.5% or even less than 1%.

According to another possible embodiment, the composition of the glassy binder phase satisfies the following formulation, in percentages by weight of the oxides:
SiO₂: between 80 and 90%;
Na₂O: between 3 and 10%;
CaO: between 1 and 10%, preferably between 2 and 6%;
MgO: between 0.1 and 5%, preferably between 0.5 and 3%;
B₂O₃: less than 5%, preferably less than 2%;

Al₂O₃: less than 2%, preferably less than 1%;
SrO+BaO: less than 1%; and
K₂O: less than 1%.

According to a third possible embodiment, the composition of the glassy binder phase satisfies the following formulation, in percentages by weight of the oxides:
SiO₂: between 80 and 90%;
Na₂O: between 1 and 10%, preferably between 2 and 6%;
K₂O: between 1 and 10%, preferably between 1 and 5%;
CaO: between 1 and 10%, preferably between 2 and 6%;
SrO+BaO: between 3 and 10%, preferably between 5 and 10%;
B₂O₃: less than 5%, preferably less than 2%; and
Al₂O₃: less than 3%, preferably less than 2%.

In the filter structure according to the invention, the refractory grains are formed by at least one material chosen from silicon carbide, alumina, zirconia, silica, titanium oxide, magnesia, aluminum titanate, mullite, cordierite and aluminum titanate, and preferably from aluminum titanate and cordierite.

It is quite obvious that the plugging material according to the invention may satisfy all possible combinations between the various initial and/or preferred ranges and values of the constituents described above and also between the various possible combinations of the constituent elements of the plugging material (composition of the grains and of the glassy phase). So as not to burden the present description unnecessarily, not all the possible combinations of said constituents are described in the present description but they must however be considered as envisioned by the applicant in the context of the present description (especially two, three or more combinations).

Furthermore, the material constituting the plugs at the first end and the material constituting the plugs at the second end may have different chemical compositions.

The present invention also relates to a catalytic filter obtained from a structure such as that described above, and by depositing, preferably by impregnation, at least one supported, or preferably unsupported, active catalytic phase typically comprising at least one precious metal such as Pt and/or Rh and/or Pd and optionally an oxide such as CeO₂, ZrO₂ or CeO₂—ZrO₂ for the treatment of the polluting gases of the CO or HC and/or NOx type and/or the combustion of soot. Such a filter is especially applicable as a catalyst support in an exhaust line of a diesel or gasoline engine or as a particulate filter in an exhaust line of a diesel engine.

The present invention also relates to an exhaust line, comprising a filter structure as described above.

In the present description, the following definitions are given:
the expression “at least one portion of the channels is closed off after sintering or firing of the honeycomb” is understood to mean that not all the channels are necessarily closed off after sintering. Thus, the inlet channels may be closed off before the structure is sintered, whereas the outlet channels are closed off after the structure has been sintered;
the expression “material constituting the plugs” is understood to mean that at least one plug of the filter structure is made of this material;
the expression “based on” is understood to mean that said walls comprise at least 50% by weight, preferably at least 70% by weight, or at least 90% or even 98% by weight of said material;
the term “median diameter”, or d₅₀, of a blend of particles or an assembly of grains, is understood in the context of the present description to mean the size that divides the particles of this blend or the grains of this assembly into the first and second populations that are equal in volume, these first and second populations comprising only particles or grains having a size greater than or less than this median diameter respectively; and
the term “powder” is understood conventionally, in the context of the present invention, to mean an assembly of grains or particles characterized by a grain size or diameter distribution in general centered on and distributed about a mean or median diameter, the term “grain” or the term “particle” being understood to mean an individual solid product in a powder or a powder blend.

The present invention also relates to a method of manufacturing a structure as described above, comprising the following main steps:
a) preparation of a composition based on the constituent material of the structure and formed, especially by extrusion of said material through a die, into a honeycomb structure;
b) optionally drying of said structure in air using a technique chosen from hot-air drying, microwave drying and freeze drying at a temperature below 130° C., or a combination of said techniques;
c) firing of said structure, possibly including an initial binder-removal step;
d) preparation of a composition for obtaining a plugging material as described previously and closing-off, by said composition, of the channels of said fired structure; and
e) firing heat treatment of the plugs placed on the ends of the fired structure.

A conventional method for manufacturing a honeycomb structure according to the present invention is given below, but this cannot be considered as a limiting aspect of one particular mode of operation.

In general, the material constituting the walls of the structures obtained according to the invention preferably has an open porosity of between 20% and 65%, and preferably between 35% and 60%. Especially in the particulate filter application, too low a porosity results in an excessively high pressure drop. On the other hand, too high a porosity results in an excessively low level of mechanical strength. The volumetric median diameter d₅₀ of the pores constituting the porosity of the material is preferably between 5 and 30 microns, more preferably between 8 and 25 microns. In general, in the intended applications, it is generally accepted that too low a pore diameter leads to too a high a pressure drop, whereas too high a median pore diameter results in poor filtration efficiency.

Advantageously, the wall thickness is between 0.2 and 1.0 mm, preferably between 0.2 and 0.5 mm. The number of channels in the filtering elements is preferably between 7.75 and 62 per cm², said channels typically having a cross section of about 0.5 to 9 mm².

For example, said structure according to the invention may also be obtained from an initial blend of particles based on aluminum titanate and/or cordierite. Advantageously, according to this embodiment the aluminum-titanate-based or cordierite-based powder has a mean diameter of less than 60 microns.

Preferably, the walls of the structure are made of a porous ceramic material based on aluminum titanate. Said porous walls may also incorporate other phases or elements in minor proportions, i.e. in general any known addition for stabilizing the aluminum titanate main phase.

The manufacturing method according to the invention most often conventionally comprises a step of mixing the initial powder blend into a homogenous product in the form of a paste, a step of extruding a green product formed through an appropriate die so as to obtain honeycomb monoliths, a step of drying the resulting monoliths, optionally an assembly step, and a firing step carried out in air or in an oxidizing atmosphere at a temperature not exceeding 1800° C., preferably not exceeding 1650° C.

The plugging step, carried out after the honeycomb monoliths have been fired, may be carried out using the method described for example in U.S. Pat. No. 4,557,773 or for example EP 1 500 482. The plugging mixtures are mixtures of dry or wet particles, capable of setting. The setting or curing of these mixtures after the channels of the structure have been closed off may result from drying or, for example, curing of a resin. Finally, heating serves to accelerate the evaporation of residual water or liquid after curing.

All refractory powders conventionally used as filler in the plugging material, which comprise a blend of refractory particles with a median diameter of between 5 and 50 microns, may be used, of course taking into account the composition of the material constituting the filtering walls. The refractory powders may for example be powders based on silicon carbide and/or alumina and/or zirconia and/or silica and/or titanium oxide and/or magnesia, or mixed powders, especially aluminum titanate or mullite powders. Preferably, the refractory powders are fused products. The use of sintered products is also possible. Preferably, the refractory powders represent more than 50%, preferably more than 70%, of the mass of the dry mineral material of the plugging mixture.

In a preferred embodiment, the plugging mixture comprises at least one aluminum titanate powder which represents at least 50%, preferably at least 80% by weight of the particulate mixture. Even more preferably, the aluminum titanate powder is the sole refractory powder used in the plugging mixture.

A glassy binder phase around the particles described above and constituting the filler of the plugging material may be obtained by melting the corresponding precursor oxides SiO₂, RO, R′₂O, B₂O₃, etc. introduced into the mixture in suitable proportions with said particles. The assembly is heated to a temperature high enough to form an essentially glassy phase coating the particles of the filler, thus forming the constituent material of the plugs. Alternatively, it is also possible to use a glass powder having the desired final composition, i.e. such as that described above, directly by mixing with the filler, the assembly then being heated to a temperature for obtaining the final plugging material. The glass powder then used preferably has a median diameter of between 5 and 50 microns.

The plugging mixture also preferably includes a temporary and/or chemical binder so as to promote its processability, in particular the suitable rheology for the plugging method used.

These binders may be chosen from the following nonexhaustive list:
Organic temporary binders, such as resins, especially thermosetting resins, i.e. those formed from at least one polymer that can be converted via thermal treatment (heat, radiation) or physico-chemical treatment (catalysis, hardener or curing agent) into an infusible and insoluble material. Thermosetting resins thus assume their final form once they have cured, reversibility being impossible. Thermosetting resins especially comprise phenolic, silicone-based or epoxy resins;
other temporary binders such as cellulose derivatives or lignin derivatives, for example carboxymethyl cellulose, dextrin, polyvinyl alcohols and polyethylene glycols;
chemical setting agents, such as phosphoric acid, alkali metal polyphosphates or aluminophosphates, or sodium silicate and derivatives thereof;
inorganic binders, such as silica gels or silica in colloidal form, binders based on silica gel and/or alumina gel or zirconia gel, chemical setting agents, such as phosphoric acid, aluminum monophosphate, etc.

The plugs produced by closing off the structure after firing may also include other organic additives, such as lubricants or plasticizers.

The plugging mixture may optionally include a pore-forming agent, for example one chosen from cellulose derivatives, acrylic particles, graphite particles and blends thereof, these being incorporated into a particulate plugging mixture so as to create porosity in order to relax the stresses on the walls and/or possibly to lighten the filter. However, the amount must not be too high, for example it must be less than 25% by weight relative to the mineral composition of the plugging mixture so as to provide sufficient sealing.

The invention relates to a honeycomb particulate filter having a structure as described above, suitable for filtering exhaust gas of a motor vehicle. Such a filter may comprise a single monolith or may be obtained by assembling, by bonding with a joint cement, a plurality of honeycomb monoliths. Such a filter may optionally include an external coating applied for example after the structure has been fired before or after the channels have been plugged. Preferably it comprises particles and/or fibers of ceramic or refractory material, chosen from oxides, especially comprising Al₂O₃, SiO₂, MgO, TiO₂, ZrO₂ or Cr₂O₃, or any mixture thereof, or even chosen from non-oxides such as SiC, aluminum nitride and/or silicon nitride, aluminum oxynitride, etc.

The invention and its advantages will be better understood on reading the nonlimiting examples that follow. In the examples, all the percentages are given by weight, especially by weight of the oxides.

### ILLUSTRATIVE EXAMPLES

a) Production of a Fused-Cast Aluminum Titanate Powder:

In all the examples, the percentages are given by weight. In a preliminary step, aluminum titanate was prepared from the following raw materials:
about 40% alumina by weight, with an Al₂O₃ purity level greater than 99.5% and a median diameter d₅₀ of 90 μm, sold under the reference AR75® by Pechiney;
about 50% titanium oxide by weight, in rutile form, comprising more than 95% TiO₂;
about 1% zirconia having a median diameter d₅₀ of about 120 μm, sold by Europe Minerals;
about 5% silica by weight, with an SiO₂ purity level greater than 99.5% and a median diameter d₅₀ of around 210 μm, sold by SIFRACO; and
about 4% by weight of magnesia powder with an MgO purity level greater than 98%, more than 80% of the particles of which having a diameter of between 0.25 and 1 mm, sold by Nedmag.

The initial reactive oxide blend was melted in an electric arc furnace, in air, under oxidizing electrical conditions. The molten mixture was then cast into a CS mold so as to undergo rapid cooling. The product obtained was milled and screened in order to obtain powders of various particle size fractions. More precisely, the milling and screening operations were carried out under conditions finally allowing the following two particle size fractions to be obtained:
a particle size fraction characterized by a median diameter d₅₀ substantially equal to 50 microns, denoted by the term “coarse fraction” according to the present invention;
a particle size fraction characterized by a median diameter d₅₀ substantially equal to 30 microns, denoted by the term “intermediate fraction” according to the present invention; and
a particle size fraction characterized by a median diameter d₅₀ substantially equal to 1.5 microns, denoted by the term “fine fraction” according to the present invention.

In the context of the present description, the median diameter d₅₀ denotes the particle diameter, measured by sedigraphy, below which 50% by volume of the population lies.

Microprobe analysis showed that all the grains of the fused phase thus obtained had the following composition below, in percentages by weight of the oxides (Table 1)

TABLE 1

| Al₂O₃ | TiO₂ | MgO | SiO₂ | CaO | Na₂O | K₂O | Fe₂O₃ | ZrO₂ | TOTAL |
|---|---|---|---|---|---|---|---|---|---|
| 40.5 | 48.5 | 3.98 | 4.81 | 0.17 | 0.15 | 0.47 | 0.55 | 0.85 | 100.00 |

b) Manufacture of Green Monoliths

Firstly, a series of dry green monoliths was synthesized in the following manner: Powders were blended according to the following composition in a mixer:
100% of a blend of two aluminum titanate powders produced beforehand by fuse casting, about 75% of a first powder with a median diameter of 50 μm and 25% of a second powder with a median diameter of 1.5 μm.

Next, the following were added, relative to the total mass of the blend:
4% by weight of an organic binder of the cellulose type;
15% by weight of a pore-forming agent;
5% of a plasticizer derived from ethylene glycol;
2% of a lubricant (oil);
0.1% of a surfactant; and
about 20% of water, so as to obtain, using the techniques of the prior art, a homogenous paste after mixing, the plasticity of which enabled a honeycomb structure to be extruded through a die, which structure, after being fired, had the dimensional characteristics given in Table 2.

Next, the green monoliths obtained were dried by microwaves for a time sufficient to bring the chemically nonbonded water content to less than 1% by weight.

The dry green monoliths were then fired, without the channels having been plugged, in air progressively to reach a temperature of 1450° C., which was maintained for 4 hours.

TABLE 2

| Example | 1 | |
|---|---|---|
| Material | Essentially aluminum | |
| | titanate phase | |
| Characteristics of the | | |
| structure after firing: | | |
| Cell cross section | Square | |
| Length | 152 | μm |
| Diameter | 144 | μm |
| Wall thickness | 350 | μm |
| Median pore diameter | 13 | μm |
| Mercury porosity | 44% | |
| Average shrinkage of the | 9% | |
| filter on being fired | | |

The porosity features were measured by high-pressure mercury porosimetry analysis carried out with a Micromeritics 9500 porosimeter.

### Examples 1 and 1a:

The green monoliths were then plugged at each of their ends, according to the conventional checkerboard configuration (on every other channel), with a plugging mixture satisfying the following formulation (in parts by weight):
100 parts of a blend of an aluminum titanate powder produced beforehand by fuse casting, the powder being milled in such a way that its median particle diameter was equal to 30 μm;
31 parts of Elkem 971U silica;
25 parts of FX300 soda-borosilicate glass powder sold by Reidt, the median diameter of which is 22 μm and the chemical composition of which is given in Table 3;
1.5 parts of a cellulose-type organic binder;
0.6 parts of a dispersant based on carboxylic acid; and
about 45 parts of water.

The monoliths, the channels of which are alternately plugged according to a conventional checkerboard pattern, were then subjected to a heat treatment up to a final temperature of 1100° C., which was maintained for 1 hour.

The experimental protocol of Example 1a was identical to that of Example 1 but was distinguished therefrom only in that the filler was a cordierite powder of substantially the same particle size distribution.

### Examples 2 and 2a:

Unlike Example 1, the fired monoliths were plugged on the side of the end or the face for bearing on the firing support using a plugging mixture satisfying the following formulation (in parts by weight):
100 parts of a blend of the aluminum titanate powder produced previously by fuse casting, with a median diameter of 30 μm;
31 parts of Elkem 971U silica;
25 parts of ST300 soda-lime glass powder sold by Reidt, the median diameter of which was 22 μm and the chemical composition of which is given in Table 3;
1.5 parts of an organic binder of the cellulose type;
0.6 parts of a dispersant based on carboxylic acid; and
about 45 parts of water.

The monoliths, the channels of which were alternately plugged according to a conventional checkerboard pattern, were then subjected to a heat treatment up to a final temperature of 1100° C., which was maintained for 1 hour.

Example 2a is distinguished from Example 2 above only in that the filler this time is obtained from the cordierite powder of Example 1a.

### Examples 3 and 3a:

Unlike Examples 1 and 2, the fired monoliths were plugged on the side of the end or face for bearing on the firing support using a plugging mixture satisfying the following formulation (in parts by weight):
100 parts of a blend of the aluminum titanate powder produced previously by fuse casting, with a median diameter of 30 μm;
31 parts of Elkem 971U silica;
25 parts of the N300 barium-strontium-soda-potash glass powder sold by Reidt, the median diameter of which was 22 μm and the chemical composition of which is given in Table 3;
1.5 parts of an organic binder of the cellulose type;
0.6 parts of a dispersant based on carboxylic acid; and
about 45 parts of water.

The monoliths, the channels of which were alternately plugged according to a conventional checkerboard pattern, were then subjected to a heat treatment up to a final temperature of 1100° C., which was maintained for 1 hour.

Example 3a is distinguished from Example 3 above only in that the filler this time was obtained from the cordierite powder of Example 1a.

### Examples 4 and 4a:

Unlike the previous examples, the fired monoliths were plugged on the side of the end or face for bearing on the firing support using a plugging mixture with a plugging mixture satisfying the following formulation (in parts by weight),
100 parts of a blend of the aluminum titanate powder produced beforehand by fuse casting, with a median diameter of 30 μm;
31 parts of Elkem 971U silica;
25 parts of the HK300 calcium-aluminum-borosilicate glass powder sold by Reidt, the median diameter of which was 22 μm and the chemical composition of which is given in Table 3;
1.5 parts of an organic binder of the cellulose type;
0.6 parts of a dispersant based on carboxylic acid; and
about 45 parts of water.

The monoliths, the channels of which were alternately plugged according to a conventional checkerboard pattern, were then subjected to a heat treatment up to a final temperature of 1100° C., which was maintained for 1 hour.

Example 4a is distinguished from Example 4 above only in that the filler this time was obtained from the cordierite powder of Example 1a.

The average thermal expansion coefficient of the material constituting the walls of the monolith was measured, on a strip of said fired material, measuring 1 cm×2.5 mm×2.5 mm, in air with a rate of temperature rise of 5° C./min until a temperature of 1100° C. was reached, by means of a Setaram dilatometer. The thermal expansion coefficient of the material constituting the walls was determined from room temperature (25° C.) to 1100° C.

The average thermal expansion coefficient under no load and under load of the plugging material was measured on a strip measuring 0.7 cm×0.7 cm×15 mm produced with the plugging material, after it had undergone the heat treatment beforehand at a temperature of 1100° C. for 1 hour, so as to obtain a sintered plugging material representative of the plugs constituting the filters according to the previous examples.

The expansion coefficient was measured from room temperature to 1100° C. with a rate of temperature rise of 5° C./min in air by means of a vertical (Setaram) dilatometer. With no load, the sensor presented a pressure of less than 0.05 MPa so as to ensure constant contact with the specimen during the test. When a load was applied, this corresponded to a stress of 0.1 MPa applied in a direction along the longest dimension of the specimen.

The adhesion of the plug to the monolith was evaluated on the plugged structure after heat treatment of the plugs. A first evaluation was carried out on the initial filter structure, before any heat treatment, by observing, using a scanning electron microscope, the plug/wall interface of the monolith on a polished specimen, in longitudinal cross section. In particular, the presence (or absence) of microcracks or of discontinuity of the structure at said interface was noted. All the specimens according to Examples 1 to 4 and 1a to 4a indicate initially satisfactory adhesion (i.e. before the thermal cycles), corresponding to perfect continuity of material at the plug/wall interface.

The durability of the adhesion of the plugs to the monolith was then evaluated by subjecting the tested filters to several thermal cycles, representative of the most stringent operating conditions of a filter placed in an exhaust line. Each cycle corresponded to heating between 500° C. and 1100° C. with a rate of rise of 5° C./min before returning to 500° C. The cycle was repeated 10 times.

As reported in Table 3, the filters according to

Examples 1, 1a, 2a and 3a comprise plugs made of a material not in accordance with the present invention. Most particularly, it can be seen from the data given in Table 3 that the thermal expansion coefficient (TEC) of these materials, at ambient pressure and under no stress, is less than 4.8×10⁻⁶ K⁻¹. Likewise, all of these materials have, under a load of 0.1 MPa, a TEC value of less than 4.5×10⁻⁶ K⁻¹.

After the durability test, observation using a scanning electron microscope of the channels/plugs interface of the filters according to Examples 1, 1a, 2a and 3a not according to the invention demonstrated the presence of cracks between the wall and the plug in all of the tested specimens.

As reported in Table 3, the filters according to Examples 2, 3, 4 and 4a comprise plugs made of a material according to the present invention. Most particularly, it may be seen from the data given in Table 3 that the thermal expansion coefficient (TEC) of these materials, at ambient pressure, is greater than 4.8×10⁻⁶ K⁻¹ when the measurement is carried out under no stress and greater than 4.5×10⁻⁶ K⁻¹ under a load of 0.1 MPa.

After the durability test, observation using a scanning electron microscope of the channels/plugs interface of the filters according to Examples 2, 3, 4 and 4a in accordance with the invention demonstrated continuity of material between the wall and the plug on all of the specimens tested, i.e. adhesion between the plugs and the walls. Most particularly, only the monoliths according to the invention, for which the composition of the glass and the filler making up the material of the plugs were chosen so as to obtain an average thermal expansion coefficient, at ambient pressure, of greater than 4.8×10⁻⁶ K⁻¹, exhibited quite remarkable adhesion after successive anneals.

It may also be seen that the glassy formulation described in Examples 4 and 4a is particularly advantageous as it results in satisfactory adhesion after the durability test, whatever the chemical nature of the filler used (cordierite or aluminum titanate).

A formulation of plugs according to the compositions described in the prior art documents (for example according to US 2006/027306), characterized by low thermal expansion coefficients of the material making up the plugs, especially close to those of aluminum titanate constituting the walls of the structure, was also subjected to the durability test described above. As indicated in Table 3, observation using an electron microscope demonstrated the presence of cracks between the walls and the plugs on the specimens tested.

TABLE 3

| | Examples | | | | | | | | |
|---|---|---|---|---|---|---|---|---|---|
| | | | | | | | | | US |
| | 1 | 1a | 2 | 2a | 3 | 3a | 4 | 4a | 2006/0272306 |
| Filler | AT** | Cordierite | AT** | Cordierite | AT** | Cordierite | AT** | Cordierite | Cordierite |
| particles | | | | | | | | | |
| of the | | | | | | | | | |
| plugging | | | | | | | | | |
| mixture | | | | | | | | | |
| Glass | FX300 | FX300 | ST300 | ST300 | N300 | N300 | HK300 | HK300 | |
| powder | | | | | | | | | |
| composition | | | | | | | | | |
| (wt %): | | | | | | | | | |
| SiO₂ | 75 | 75 | 71.9 | 71.9 | 60.6 | 60.6 | 53 | 53 | 78.6 |
| Al₂O₃ | 5 | 5 | 0.6 | 0.6 | 2.8 | 2.8 | 14.4 | 14.4 | 0.09 |
| Na₂O | 7 | 7 | 13.9 | 13.9 | 8.5 | 8.5 | 0.3 | 0.3 | |
| K₂O | | | 0.2 | 0.2 | 6.7 | 6.7 | 0.4 | 0.4 | 2.77 |
| CaO | 1.5 | 1.5 | 8.7 | 8.7 | 1.0* | 1.0* | 23 | 23 | |
| MgO | | | 3.8 | 3.8 | | | 0.5 | 0.5 | |
| SrO | | | | | 8.5 | 8.5 | | | |
| BaO | | | | | 8.6 | 8.6 | | | |
| B₂O₃ | 10.5 | 10.5 | | | | | 7.5 | 7.5 | 18.6 |
| TEC of the | 5 | | 8.7 | | 8.9 | | 6.0 | | |
| glass | | | | | | | | | |
| (10⁻⁶ K⁻¹) | | | | | | | | | |
| Softening | 785 | | 725 | | 710 | | 840 | | |
| temperature | | | | | | | | | |
| of the | | | | | | | | | |
| glass (° C.) | | | | | | | | | |
| Composition | | | | | | | | | |
| of the | | | | | | | | | |
| glassy | | | | | | | | | |
| binder | | | | | | | | | |
| phase of | | | | | | | | | |
| the plug | | | | | | | | | |
| (wt %) | | | | | | | | | |
| SiO₂ | 88.8 | 88.8 | 87.4 | 87.4 | 82.3 | 82.3 | 78.9 | 78.9 | 85.7 |
| Al₂O₃ | 2.3 | 2.3 | 0.3 | 0.3 | 1.3 | 1.3 | 6.5 | 6.5 | 0.1 |
| Na₂O | 3.2 | 3.2 | 6.3 | 6.3 | 3.8 | 3.8 | 0.1 | 0.1 | |
| K₂O | | | 0.1 | 0.1 | 3.0 | 3.0 | 0.2 | 0.2 | 1.8 |
| CaO | 0.7 | 0.7 | 3.9 | 3.9 | 0.5* | 0.5* | 10.4 | 10.4 | |
| MgO | | | 1.7 | 1.7 | | | 0.2 | 0.2 | |
| SrO | | | | | 3.8 | 3.8 | | | |
| BaO | | | | | 3.9 | 3.9 | | | |
| B₂O₃ | 4.7 | 4.7 | | | | | 3.4 | 3.4 | 12.4 |
| TEC: walls | 2 | 2 | 2 | 2 | 2 | 2 | 2 | 2 | |
| of the | | | | | | | | | |
| unplugged | | | | | | | | | |
| monolith | | | | | | | | | |
| (10⁻⁶ K⁻¹) | | | | | | | | | |
| TEC: filler | 10 | 2 | 10 | 2 | 10 | 2 | 10 | 2 | |
| particles | | | | | | | | | |
| of the | | | | | | | | | |
| plugging | | | | | | | | | |
| mixture | | | | | | | | | |
| (10⁻⁶ K⁻¹) | | | | | | | | | |
| TEC (with | 4.2 | 3.1 | 8.2 | 3.7 | 7.7 | 4.7 | 6.7 | 5.5 | |
| no load) of | | | | | | | | | |
| the plug | | | | | | | | | |
| material | | | | | | | | | |
| (10⁻⁶ K⁻¹) | | | | | | | | | |
| TEC (under | 2.2 | 1.2 | 5.5 | 3.1 | 6.7 | 4.4 | 5.9 | 5.1 | |
| 0.1 MPa) of | | | | | | | | | |
| the plug | | | | | | | | | |
| material | | | | | | | | | |
| (10⁻⁶ K⁻¹) | | | | | | | | | |
| Wall | YES | YES | YES | YES | YES | YES | YES | YES | YES |
| adhesion | | | | | | | | | |
| before | | | | | | | | | |
| thermal | | | | | | | | | |
| cycling | | | | | | | | | |
| Wall | NO | NO | YES | NO | YES | NO | YES | YES | NO |
| adhesion | | | | | | | | | |
| after | | | | | | | | | |
| thermal | | | | | | | | | |
| cycling | | | | | | | | | |

CaO + MgO;
** Aluminum titanate.

1. A honeycomb type filter structure suitable for filtering a particulate-laden gas, the structure comprising:
adjacent longitudinal channels having mutually parallel axes, and comprising a first end and a second end, and
porous filtering walls separating the channels,
wherein each of the channels is independently plugged at either the first end or the second end of the structure to define inlet and outlet channels suitable for filtering the gas, thereby requiring the gas to pass through the porous walls to pass through the structure,
the filtering walls comprise a filtering wall material having, after firing, an average thermal expansion coefficient, measured between 25 and 1100° C., of less than 2.5×10⁻⁶ K⁻¹,
the plugs comprise a plug material that comprises a filler and a glassy binder phase,
the filler is obtained by a process comprising forming the filler from refractory grains having a melting temperature above 1500° C. and a median diameter of between 5 and 50 microns, and
the glassy binder phase has a content, in percentage by weight, of oxides:
SiO₂: between 50 and 95%,
a total content of between 0.1 and 15% of at least one alkaline-earth metal oxide,
a total content of between 0.1 and 10% of at least one alkali metal oxide,
Al₂O₃: less than 20%,
B₂O₃: less than 10%, and
MgO: less than 5%.

2. The filter structure of claim 1, wherein an average thermal expansion coefficient of the plug material, measured between 25 and 1100° C. and not stressed, is at least equal to 4.8×10⁻⁶ K⁻¹.

3. The filter structure of claim 1, wherein an average thermal expansion coefficient of the plug material, measured between 25 and 1100° C. under a load of 0.1 MPa, is at least equal to 4.5×10⁻⁶ K⁻¹.

4. The filter structure of claim 1, wherein a shrinkage of the plug material measured between 25 and 1100° C. under a load of 0.1 MPa, is less than 2.5%.

5. The filter structure of claim 1, wherein the glassy binder phase has a content, in percentage by weight, of oxides:
SiO₂: between 65 and 95%,
CaO: between 0.5 and 15%,
Na₂O: between 0.05 and 10%, a total combined content of CaO and Na₂O: between 3 and 25%,
Al₂O₃: less than 15%,
B₂O₃: less than 10%, and
MgO: less than 5%.

6. The filter structure of claim 1, wherein the glassy binder phase has a content, in percentage by weight, of oxides:
SiO₂: between 70 and 85%,
B₂O₃: between 1 and 10%,
CaO: between 5 and 15%,
Al₂O₃: between 4 and 10%, and
a total combined content of SrO and BaO: less than 1%.

7. The filter structure of claim 6, wherein the total content of the at least one alkali metal oxide in the glassy binder phase is less than 3%.

8. The filter structure of claim 1, wherein the glassy binder phase has a content, in percentage by weight, of oxides:
SiO₂: between 80 and 90%;
Na₂O: between 3 and ¹⁰%.,
CaO: between 1 and 10%,
MgO: between 0.1 and 5%,
B₂O₃: less than 5%,
Al₂O₃: less than 2%,
a total combined content of SrO and BaO: less than 1%, and K₂O: less than 1%.

9. The filter structure of claim 1, wherein the glassy binder phase has a content, in percentage by weight, of oxides:
SiO₂: between 80 and 90%,
Na₂O: between 1 and 10%,
K₂O: between 1 and 10%,
CaO: between 1 and 10%,
a total combined content of SrO and BaO: between 3 and 10%,
B₂O₃: less than 5%, and
Al₂O₃: less than 3%.

10. The filter structure of claim 1, wherein the refractory grains comprise silicon carbide, alumina, zirconia, silica, titanium oxide, magnesia, aluminum titanate, mullite, cordierite, or a combination thereof.

11. The filter structure of claim 1, wherein the walls comprise a material based on aluminum titanate or on cordierite.

12. The filter structure of claim 1, wherein the plug material at the first end and the plug material at the second end have different chemical compositions.

13. The filter structure of claim 1, further comprising:
a supported or unsupported active catalytic phase.

14. An exhaust line, comprising the filter structure of claim 1.

15. A method of manufacturing the structure as of claim 1, the method comprising:
forming the filtering wall material into a honeycomb structure;
optionally drying of the structure in air by hot-air drying, microwave drying, lyophilization drying at a temperature below 130° C., or a combination thereof;
firing the structure, to obtain a fired structure with channels, a first end, and a second end;
closing-off the channels of the fired structure with the plug material; and
firing the plug material on the ends of the fired structure.

16. The filter structure of claim 2, wherein the average thermal expansion coefficient of the plug material, measured between 25 and 1100° C. and not stressed, is at least equal to 5.0×10⁻⁶ K⁻¹.

17. The filter structure of claim 3, wherein the average thermal expansion coefficient of the plug material, measured between 25 and 1100° C. under a load of 0.1 MPa, is at least equal to 5.0×10⁻⁶ K⁻¹.

18. The filter structure of claim 13, wherein the active catalytic phase comprises a precious metal.

19. The filter structure of claim 18, wherein the precious metal comprises Pt, Rh, Pd, or any combination thereof.

20. The filter structure of claim 18, wherein the active catalytic phase further comprises CeO₂, ZrO₂, CeO₂—ZrO₂, or any combination thereof.
